(19) United States
(12) Patent Application Publication
(10) Pub. No.: US 2025/0236425 A1
(43) Pub. Date: Jul. 24, 2025

(54) METHOD OF INDUSTRIAL PRODUCTION AND PACKAGING OF SPUN SUGAR

(71) Applicant: RICOIRA FOODS PVT LTD., Pune (IN)

(72) Inventor: Ashish KOMALKUMAR NIMJE, Bhandara Maharashtra (IN)

(21) Appl. No.: 18/699,811

(22) PCT Filed: Oct. 10, 2022
(86) PCT No.: PCT/IN2022/050909

§ 371 Date: Apr. 9, 2024

(30) Foreign Application Priority Data
Oct. 10, 2021 (IN) 202121046138

(51) Int. Cl. B65B 25/00; A23G 3/34; B65B 5/06; B65B 7/28; B65B 53/00; B65B 55/00

(52) U.S. Cl. CPC B65B 25/005; A23G 3/0051; B65B 5/062; B65B 7/2878; B65B 53/00; B65B 55/00

(57) ABSTRACT

A method of producing and packaging of spun sugar is described. The process may include the steps of (a) obtaining liquefied sugar in a floss head, by heating sugar at a temperature of 126-140C; (b) instantly cooling the liquefied sugar to obtain sugar threads wherein the hygroscopicity of the sugar threads is kept low by carrying out both steps above under a controlled environment; (c) packaging of the Candy Floss/Spun Sugar in cups/containers of Candy Floss/Spun Sugar which are sealed with a specialized lid, wherein the ratio of the weight of Candy Floss/Spun Sugar (in grams) to the volume of the cup (in ml) is kept within control on the basis of an experimentally derived ratio; (d) re-packaging the cups of Candy Floss/Spun Sugar, in a secondary packaging material under a controlled environment which further helps in reducing moisture transmission inside primary packaging.

### FIELD OF INVENTION

The invention relates to the combined field of physics & chemistry particularly to the method of industrial production and packaging of Spun Sugar (Popularly known as Cotton Candy) which increases its shelf life by upto 9 (nine) months thereby making it commercially viable and affordable to store, transport & distribute widely at room temperature while retaining its Original Form.

### BACKGROUND OF THE INVENTION

“Cotton Candy” (also known as Candy Floss/Spun Sugar) is a very popular confectionary which is consumed widely all over the world. It is available in a wide variety of colours and flavours and it is favourite sweet confectionary of children as well as adults of all ages. Spun Sugar can be simply defined as threads of sugar. In its Original Form Cotton Candy resembles a soft cloud or tufts of sugar threads (herein referred to as ‘Original Form’). The main chemical contents of Spun Sugar are Sugar (or Raw Sugar), air, flavouring and colouring agents. Spun Sugar is widely available in open markets where it is primarily sold across live counters in the form of ready to eat confectionery prescribed for immediate consumption, however, it can't be stored for longer periods of time. Industrial Production & Packaging of Spun Sugar is fret with its own challenges and limitations which hampers its production on a mass scale. Although the product is a very well-established product in the market, however, there are a large number of impediments which are suffered in Industrial Production of Spun Sugar because of the nature of the product itself which makes it nearly impossible to produce, store, pack, transport and distribute commercially on a mass-scale like any other sweet or confectionary. Cotton Candy in its original form i.e. in the form of soft cloud or tufts of sugar threads is very sensitive to the water content/moisture in the atmosphere and even slightest of exposure to moisture can lead to erosion of its original form which spoils its taste and feeling of eating a soft candy.

The problem currently faced by the Spun Sugar Industry is that if Cotton Candy is industrially produced, packed, stored and distributed like any other sweet or confectionary, then the crystalline sugar threads of Cotton Candy collapse into amorphous powder like structure or convert into rubber like form initially and eventually solidifies over the period of time on exposure to atmospheric moisture. In other words, Cotton Candy loses it original form i.e. form of soft cloud or tufts of sugar threads, which is nearly impossible to retain for longer periods of time. That is why Cotton Candy is only sold over live counters i.e. as soon as it is produced it is prescribed for immediate consumption.

Once Spun Sugar losses its thread like structure i.e. original form, it cannot be sold as Cotton Candy and it has no commercial value. The storage life or the shelf life of the Spun Sugar is very limited. The currently available product(s) in the market can retain its thread-like structure at best for 3 (three) months only and beyond that Cotton Candy entirely loses its thread-like structure as well as its commercial value. In order to touch multiple retail points under normal storage conditions/room temperature across the entire supply chain, Cotton Candy should retain its thread-like structure throughout the supply chain to make it commercially valuable. (*Supply Chain=Spun Sugar Production→Packing→Transportation at Hub and Distribution Centers→Retailers and Retail Shelves→Purchase by Consumer→Storage at Home→Final Consumption). Thus, in order to be commercially viable, Cotton Candy should be capable of being stored under normal conditions/room temperature for a minimum of 9 (nine) months to achieve any significant economic gain and this problem is solved by the present invention which proposes a method of industrial production and packaging of Cotton Candy which increases its shelf life by upto 9 (nine) months.

A few of the prior art focuses on the packaging methods for cotton candy however they don't result in enhancing the shelf life of Cotton Candy. For example, KR20150115563A relates to a cotton candy packaging material and method for enabling cotton candy packaging into containers so that they embed the cotton candy inside it thereby giving it a unique shape. Under this, Cotton Candy bags having shapes of each part are generated and cotton candy is packed into individual bags which are then brought together to generate the overall unique shape of the cotton candy. This prior art is directed more towards satisfying the aesthetic needs of a consumer by putting Cotton Candy into unique shape of a rag doll. This method is to enhance attractiveness of Cotton Candy and this method is focused more on the appearance of the final product rather than having any effect on increasing the shelf life of the product. EP1522224A1 discloses a method for marketing and selling cotton candy and it comprises putting cotton candy obtained from molten sugar to form a fluffy wad of cotton candy and position-ing the fluffy wad of cotton candy in a rigid, sealed container through an opening in the container. The rigid container defines a static volume which surrounds the cotton candy wad and generally prevents the wad from being easily compressed, however the method focuses more on rigidity of container and air-tight packaging of the cotton candy which can be expensive and also requires a gas-impermeable seal of the lid with the container. Further just by using an air-tight container and using a gas-impermeable seal, the product claims to establish a shelf-life of only one month, which does not help improving the commercial value of the Spun Sugar where a longer shelf-life is desirable.

CN103652231A discloses a pulp cotton candy mainly comprising of cotton candy body and pulp, wherein the pulp is wrapped in the cotton candy body and dried fruits are adopted as the pulp; a layer of sugar surface is arranged outside the cotton candy body; the cotton candy body is in the shape of a flower. Thus, this prior art teaches making a totally new form of dessert which is made out of combining marshmallow and cotton candy and doesn't relate to widely available Cotton Candy/Spun Sugar.

JP2001333696A discloses a different method of manufacturing the cotton candy which is starkly different from traditional method of manufacturing cotton candy. Moreover, the application JP2001333696A discloses storage life of Cotton Candy of up to only three months. The invention thus teaches to use a solid form of sugar and a different method of obtaining the candy floss than used in a commercial set-up. Moreover, it is two step manufacturing process which doesn't produce regular classic cotton candy.

Therefore, in order to make Spun Sugar viable for commercial purposes so that it retains its original form for a period of at-least 9 (nine) months, an alternative method of industrial production and packaging of Spun Sugar is needed that overcomes the problems stated in prior art, hence, the present patent application.

### OBJECT OF THE INVENTION

The object of the present invention is to devise an affordable and cost effective method for industrial production & packaging of Spun Sugar such that the Spun Sugar can retain its original form i.e. in the form of soft cloud or tufts of sugar threads having increased shelf life of upto nine months which makes it commerically viable to produce, store, pack, distribute and transport on a mass-scale.

### SUMMARY OF THE INVENTION

This summary is provided to introduce a selection of concepts from the invention in a simpli-fied format whereas the complete invention is further described in detail in later part of the document. This summary is neither intended to identify key or essential inventive concepts of the invention or it is intended for determining the scope of the invention.

The present invention discloses a method of industrial production of spun sugar comprising the following steps to be carried out under a controlled environment: (a) obtaining liquefied sugar in a floss head using commonly available Candy Floss machine, by heating sugar at a temperature of 126-140° C.; (b) instantly cooling the liquefied sugar obtained in step (a) to obtain sugar threads wherein the hygroscopicity of the sugar threads is kept low by carrying out both steps (a)& (b) above under a controlled environment i.e. temperature and relative humidity across various stages of industrial production is maintained or required to be kept constant within experiment tally derived numeral ranges which are found to be best suited for the method described herein.

The present invention further discloses a method of industrial packaging of spun sugar as produced above to be again carried out under controlled environment wherein packaging consists of: (a) packaging of the Candy Floss/Spun Sugar in a primary packaging material to obtain cups/containers of Candy Floss/Spun Sugar which are sealed with a specialized lid, wherein the ratio of weight of Candy Floss/Spun Sugar (in grams) to the Volume of the cup (in ml) is kept within control on the basis of an experimentally derived ratio which keeps the hygroscopicity of Cotton Candy low by regulating the volume of air that enters into the primary packaging; (b) re-packaging the primary packaging i.e. cups of Candy Floss/Spun Sugar, in a secondary packaging material under a controlled environment. The secondary packaging further helps in reducing moisture transmission inside primary packaging and it is supported with additional shrink-wrap on the outside.

### BRIEF DESCRIPTION OF FIGURES

These and other features, aspects, and advantages of the present invention are to be read with detailed description given below herein which assists in understanding the accompanying figures:

FIG. 1 depicts commonly available Candy Floss machine that is available in the market and 5, which is used to produce Cotton Candy commercially.

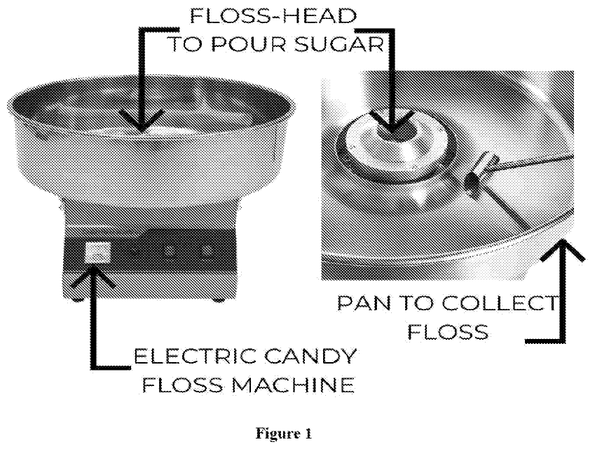

FIG. 2 depicts Original Form of Cotton Candy i.e. in the form of clouds or tufts of sugar threads.

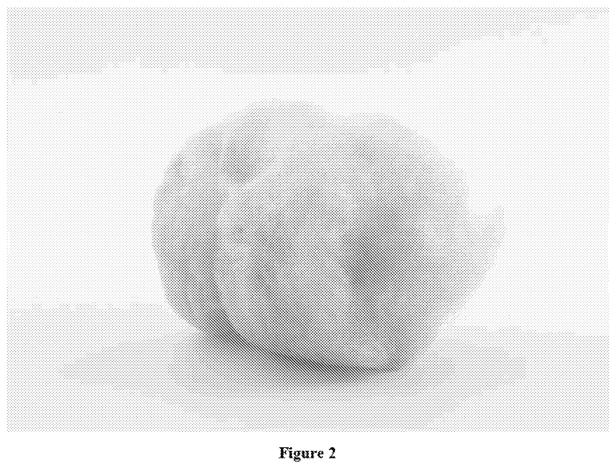

FIG. 3 shows Cotton Candy eroded from its Original Form i.e. reduced into rubber like form which eventually converts into stone like structure on exposure to atmospheric moisture.

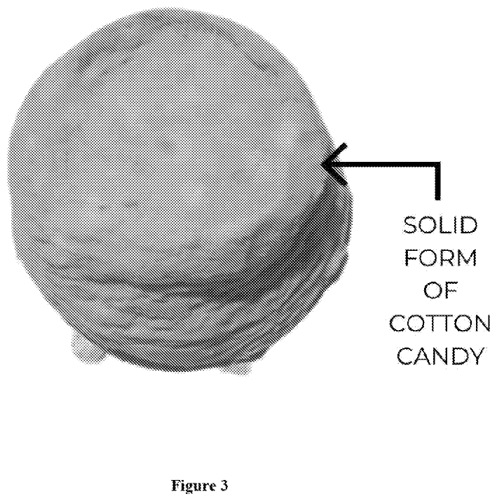

FIG. 4 shows Cotton Candy eroded from its Original Form i.e. reduced into powdery form/amorphous like structure on exposure to atmospheric moisture.

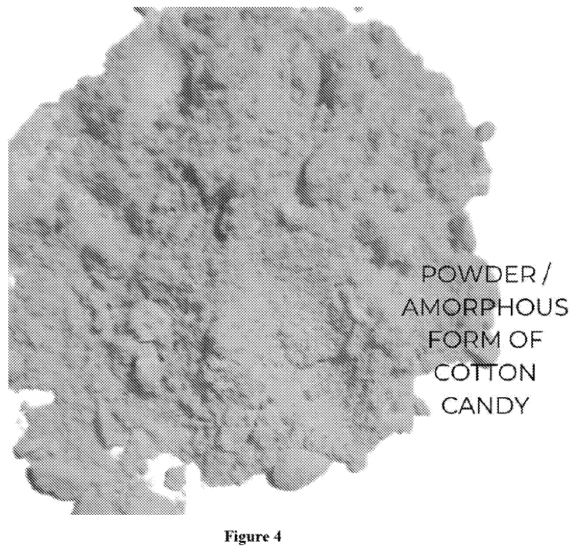

FIG. 5 shows Primary Packaging consisting of rigid PP cup/container sealed with laminated paper poly foil along-with top view of the same.

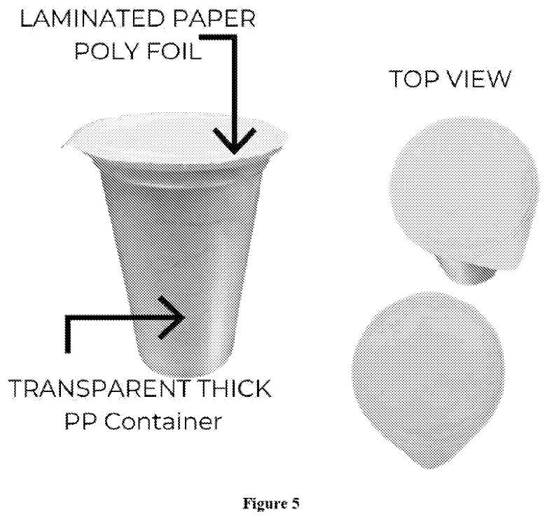

FIG. 6 shows Secondary Packaging which consists of 3-ply corrugated paper box covered with Shrink Wrap.

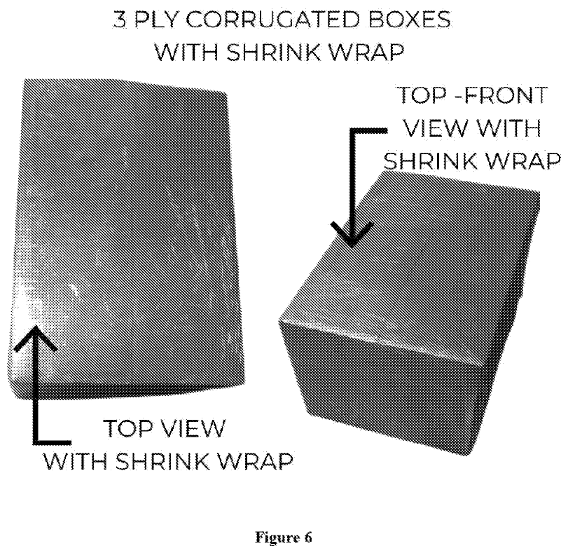

Further, skilled artisans will appreciate that elements in the figures are illustrated for simplicity and may not have been necessarily drawn to scale. For example, the flow charts illustrate the method in terms of the most prominent steps involved in comprehending crucial aspects of the present invention. Furthermore, in terms of the construction of the device, one or more components of the device may have been represented in the figures using conventional symbols, and the figures may show only those specific details that are pertinent to understanding the embodiments of the present invention so as not to obscure the figures with details that will be readily apparent to those of ordinary skill in the art having benefit of the description herein.

### DETAILED DESCRIPTION

For the purpose of promoting an understanding of the principles of the invention, reference will now be made to the embodiment illustrated in the figures and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates. It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present invention.

Thus, appearances of the phrase “in an embodiment”, “in another embodiment” and similar language throughout this specification may, but do not necessarily, all refer to the same embodiment. The terms “comprises”, “comprising”, or any other variations thereof, are intended to cover a non-exclusive inclusion, such that a process or method that comprises a list of steps does not include only those steps but may include other steps not expressly listed or inherent to such process or method.

Similarly, one or more devices or sub-systems or elements or structures or components proceeded by “comprises” does not, without more constraints, preclude the existence of other devices or other sub-systems or other elements or other structures or other components or additional devices or additional sub-systems or additional elements or additional structures or additional components. Unless otherwise defined, all technical and scientific terms used herein have the same meaning as commonly understood by one of ordinary skill in the art to which this invention belongs. The system, methods, and examples provided herein are illustrative only and not intended to be limiting.

“Relative humidity”—as the amount of water vapor present in air expressed as a percentage of the amount needed for saturation at the same temperature.

“Primary Packaging”—Primary packaging is the main package that holds the food that is being processed.

“Secondary packaging” is the packaging that holds together the individual units of primary packaging together. The secondary packaging helps in reducing moisture transmission within primary packaging and is covered with shrink-wrap.

“Laminated Paper Poly Lid” means lid that is used to cover the polypropylene plastic (PP) cup/containers from the top in order to prevent the heat transmission and it consists of minimum three layers:
1. Laminated Paper of minimum thickness 110 GSM—to obstruct direct sunlight and to minimize heat transfer to the inner product;
2. Aluminum foil—the best foil material for least MVTR (Moisture Vapor Transmission Rate), O₂ or CO₂ transmission; and
3. Poly (LD or lacquered material)—which can fit snugly with PP Containers using heat sealing method.

“Spun Sugar or Cotton Candy or Candy Floss” is highly porous and contains sugar threads with more than 90% as air. It can be roughly defined as a lump of fluffy sugar threads in the form of cloud like structure separated by air/space. The typical taste or feeling of having Spun Sugar is due to its particular form i.e. because of its fluff/cloud and thread-like structure. Squeezing out of all air from the Spun Sugar reduces Spun Sugar to a solid cake like form such that the density of the product is increased in terms of having more sugar threads as compared to air and this makes it dense in terms of having less air which has the effect of drastically changing the taste or feeling of having Spun Sugar. At the same time, Spun Sugar containing high air and low sugar threads contents is susceptible to absorbing moisture content from the air and it becomes very difficult to maintain the shelf life of Spun Sugar for more than 3 (three) months. Therefore, appropriate balance has to be maintained and the inventors of present application have conducted meticulous testing and detailed experiments to determine in what ratio Cotton Candy can be packaged in primary packaging material for extended shelf life. Few manufacturers from developed countries have squeezed the Spun Sugar to a dense form and they claims 9 to 12 months of shelf life on label for example—Fluffy Stuff from USA. Such Spun Sugar which is more dense tastes entirely different from thread-like structure and consumer can easily differentiate between fresh Spun Sugar and more densely packed caked structure of Spun Sugar which tastes and feels entirely different. The taste changes (due to such packaging which is dense) therefore leads to rejection of the Spun Sugar by the consumer. Presently, there is no solution to the existing problem of Spun Sugar manufacturing and packaging which increases its shelf life while at the same time keeping costs low which makes it commercially viable to industrially produce and package Spun Sugar on a mass scale. The present invention exactly deals with this problem and offers a method of industrial production and packaging of Spun Sugar which is very cost effective and provides increased shelf life of Spun Sugar for upto 9 (nine) months thereby making it commercially viable so as to provide significant economic gain.

The present invention discloses a method of industrial production of spun sugar comprising the following steps to be carried out under a controlled environment: (a) obtaining liquefied sugar, in a floss head, by heating sugar at a temperature of 126-140° C.; (b) instantly cooling the liquefied sugar obtained in step (a) to obtain sugar threads wherein the hygroscopicity of the sugar threads is kept low by maintaining room temperature and relative humidity between experimentally derived numeral ranges i.e. room temperature has to be maintained between 15-25° C. and relative humidity of the room has to be maintained between 25-35 so that the moisture content in the air can be controlled to produce the best results which complements the method of packaging described below.

The present invention further discloses a method of industrial packaging of spun sugar as produced above to be again carried out under the same controlled environment wherein room temperature is maintained between 15-25° C. and relative humidity of the room is maintained between 25-35. This helps in controlling the moisture content in the air which goes into primary packaging along with Cotton Candy and primary packaging consists of: (a) packaging of the Candy Floss/Spun Sugar in a primary packaging material to obtain cups of Candy Floss/Spun Sugar which are sealed with a specialized lid, wherein the ratio of weight of Candy Floss/Spun Sugar (in grams) to the volume of the cup/container (in ml) is kept within control on the basis of an experimentally derived ratio which keeps the hygroscopicity of Cotton Candy low by controlling the volume of air that enters into primary packaging i.e. ratio of weight of Cotton Candy (in grams) to Volume of Primary Packaging (in ml) is to be kept above 1:14.70588 in order to obtain increased shelf life; (b) re-packaging the primary packaging i.e. cups of Candy Floss/Spun Sugar, in a secondary packaging material under a controlled environment. The secondary packaging further helps in reducing moisture transmission inside primary packaging and it is supported with additional shrink-wrap on the outside.

Relative humidity can be defined as the amount of water vapor present in air expressed as a percentage of the amount needed for saturation at the same temperature.

Both relative humidity and room temperature are important factors and parameters during the manufacturing and packaging of Cotton Candy that affect the shelf life of end product. The inventor of the present application surprisingly found that controlling these two parameters during the manufacturing & packaging process drastically increases the shelf life of Spun Sugar produced. However, at the same time inventor of the present application noticed that in case temperature and relative humidity is kept outside the experimentally derived numeral ranges then the Shelf Life of the Cotton Candy drastically reduced. With repeated testing under controlled environment the inventor of the present application was able to derive the numeral ranges of temperature and relative humidity, which is best suited to produce the desired result when coupled with packaging process described herein.

Accordingly in one embodiment the present invention discloses a method of industrial production of Spun Sugars/Cotton Candy under controlled environment, wherein the room temperature is maintained in experimentally derived numeral range of 15-25° C. and relative humidity is maintained in the numeral range of 25-35 which is best suited to produce the desired result.

However, the process of industrial packaging of the Spun Sugar is equally important and it further enhances the shelf life of the end product. Not only it is important to control the relative humidity and room temperature during manufacture of the product but also ensure that packaging of the product is carried out in the same controlled environment which contains the moisture in the air within desirable range that helps maintain thread-like structure of Cotton Candy for a longer term as during primary packaging air gets filled in the cup also which plays an important part in determining whether Spun Sugar will be able to retain its Original Form or not. It is a common observation that if Spun Sugar is loosely packed, it gets damaged in few days that is to say it loses its thread-like structure and solidifies in short term. The main reason behind this is that during the packaging of the product, air also gets filled in the primary package along—with Spun Sugar. The air contains absolute moisture (i.e. water molecules) and balance of spun sugar to air packed inside the primary packaging is not maintained, then Spun Sugar absorbs more moisture and its physical form collapses before actual consumption of Spun Sugar (last stage of supply chain). With repeated testing and experimentation the inventors of the application have found out the magic ratio, which works best to produce desired result of increasing the shelf life of Cotton Candy. It is experimentally derived that ratio of weight of Cotton Candy (in grams) to Volume of Primary Packaging (in ml) is to be kept above 1:14.70588 in order to obtain increased shelf life of Cotton Candy.

Further ahead, the Spun Sugar is packaged in a primary packaging followed by a secondary packaging, which further enhances the shelf life of the Cotton Candy and controls exchange of moisture between Primary Packaging and atmosphere. In one embodiment, the method of packaging of Candy Floss comprises of a primary packaging of polypropylene plastic (PP) contain-er/cup having experimentally derived uniform thickness of 190-220 microns which is further sealed from the top with laminated paper polyfoil lid that fits snugly with the polypropylene plastic (PP) container/cup. The thickness of polypropylene plastic (PP) container/cup which forms primary packaging plays a crucial role as it regulates flow of air inside and outside the primary packaging cup. The numeral range of appropriate thickness for the present invention to work is also derived experimentally by the inventor. It is observed that in case the thickness of polypropylene plastic (PP) container/cup is kept outside the experimentally derived numeral range then it fails to produce the desired result. Therefore, only specially made polypropylene plastic (PP) container/cups having uniform thickness of 190-220 microns are required as primary packaging material for the present invention to work. It is further observed that cost of packaging increases if thickness of polypropylene plastic (PP) container/cups is increased. Therefore, keeping the cost of packaging low is also the aim of the present invention, which helps in achieving scalability while keeping the end product affordable for the Consumer. In case the primary packaging material for Candy Floss/Spun Sugar includes polypropylene plastic (PP) cups/containers of thickness outside the experimentally derived numeral range then it leads to product damage. The commonly available polypropylene plastic (PP) containers/cups are of weight 4-5 gms, which offers a less expensive alternative however Cotton Candy cannot be successfully commercialized in these polypropylene plastic (PP) containers/cups due to the fact that these containers/cups are unable to keep out the moisture for long hence it results in moisture absorption by the Spun Sugar.

The second option of primary packaging commonly available in market is to use very heavy polypropylene plastic (PP) containers/bucket, weighing about 25-60 grams. These containers are not economical, and thus raise the total cost of the product hence lowers affordability for the end consumer and also increase the total cost of production which erodes commercial viability. It is important to mention here that PP (Polypropylene Plastic) is preferred over PET (Polyethylene) because of very low MVTR (Moisture Vapor Transmission Rate) in polypropylene plastic (PP), which is ideal for controlling ingress of air containing moisture into the primary packaging. Moreover, use of the polypropylene plastic (PP) material is economical which lowers packaging cost, giving economical scale impact.

Further after putting Cotton Candy in Primary Packaging, the polypropylene plastic (PP) container/cups are sealed with laminated paper polyfoil lid that fits snugly. The use of laminated paper polyfoil to seal the top of Primary Packaging has experimentally proven to be the best choice for the invention to work as it prevents heat transmission and stabilized thermodynamics and entropy inside the Primary Packaging thereby helping in creating an isolated system inside the Primary Packaging. The inventor of the present application carried out testing with various other materials but best results were produced only by using laminated paper polyfoil lid to seal the top of Primary Packaging. Moreover, the LD in the lid covering melts and becomes one with PP Cup forming a sealing ring as per heat sealing method which results in lid fitting snugly on top of PP Cup.

Another alternative which is commonly available in the market is—regular aluminum foil (Aluminum+Poly (LD or lacquered material). However, if the same is used then the product gets damaged as the heat transmission cannot be prevented by (Aluminum+Poly (LD or lacquered material) lids and it doesn't help in creating an isolated system inside the Primary Packaging.

In the present invention a special laminated paperpoly foil is used as a lid to cover the Primary Packaging, which is used in pharma industry generally. It has minimum three layers and further multiple layers can also be added. However, following three layers are essential in the lid that covers the polypropylene plastic (PP) cup/containers in order to prevent the heat transmission and produce best results:
1. Laminated Paper of thickness of atleast 110 GSM—to obstruct direct sunlight and to minimize heat transfer to the inner product;
2. Aluminum foil—the best foil material for least MVTR (Moisture Vapor Transmission Rate), O₂ or CO₂ transmission; and
3. Poly (LD or lacquered material)—which can fit snugly with PP Containers using heat sealing method.

Preventing heat transmission is even more important in countries like India where (1) extreme climatic conditions are seen, (2) logistics pose challenges of maintaining appropriate cold storage conditions across the supply chain (3) many small retail shops lack air conditioning and proper storage. Therefore, present invention solves the problem of storage and transport of Cotton Candy, which doesn't require any special conditions. On the other hand present invention proposes a method of packaging of Cotton Candy which renders it convenient to store and transport at room temperature.

In still another embodiment the present invention discloses a method of packaging of Spun Sugar in Primary Packaging and sealing the same with laminated paper polyfoil lid. In another embodiment the present invention discloses method of Secondary Packaging of spun sugar wherein the secondary packaging consists of minimum 3-ply corrugated boxes inside which Primary Packaged Cups of Cotton Candy are put and the 3-ply corrugated boxes are supported with additional shrink-wrap on the outside.

In order to further extend Shelf Life of Spun Sugar, the primary packaging is packed and sealed in minimum 3-ply-corrugated boxes. Secondary packaging is the packaging that holds together the individual units of Cotton Candy and holds primary packaging together. The secondary packaging further is supported with:
1. Full Shrink Wrap—to eliminate direct contact with air and lower moisture transmission rate;
2. Commercially available food grade moisture absorbers packed inside 3-ply corrugated boxes to absorb and thereby lower the moisture present inside secondary packaging.

The above packaging method fully protects the product from any damages and this method of Packaging Cotton Candy is being first time used in India and is being disclosed in present patent application.

### EXAMPLE

The following examples are for illustration purposes and are not to be construed as limiting the invention disclosed in this document to only the embodiments disclosed in these examples.

### Example 1

### Industrial Production of the Spun Sugar

Spun Sugar is produced with commonly available Candy Floss/Spun Sugar machine in an industrial setup under controlled environment. Sugar gets melted in floss-head with the help of heating element (which heats the sugar at the temperature range of 126-140° C.) and then the liquefied sugar is cooled instantly in the same floss-head with help of rotation mechanism to yield Spun Sugar or Cotton Candy i.e. a thread-like structure of sugar.

The hygroscopicity of the sugar threads is kept low by keeping the room temperature and relative humidity within experimentally derived numeral ranges of 15-25° C. and 25-35 respectively which is empirically found to be best suited to produce the desired result.

### Example 2

### Primary Packaging

Polypropylene plastic (PP) container/cups having experimentally derived uniform thickness of 190-220 microns are to be used as container/cups and found to be best suited to store Cotton Candy while retaining its Original Form. Cotton Candy as produced in Example 1 is inserted into the said Polypropylene plastic (PP) containers/cups. Since, room air also enters the Polypropylene plastic (PP) container/cup at the time of packaging therefore it is important that Primary packaging is also carried out under controlled environment i.e. temperature and relative humidity has to be kept within experimentally derived numeral ranges of 15-25° C. and 25-35 respectively throughout the process. Moreover, while inserting the Cotton Candy into Polypropylene plastic (PP) container/cup, ratio of weight of Cotton Candy (in grams) to Volume of Primary Packaging (in ml) is to be kept above experimentally derived ratio of 1:14.70588 in order to obtain the desired result. The Polypropylene plastic (PP) container/cup is sealed from the top using heat sealing method with laminated paper-poly foil made up of atleast three layers i.e. one layer consisting of laminated paper of atleast 110 GSM of thickness, second layer consisting of Aluminum foil and third layer consisting of Poly (LD or lacquered material) which fits snugly with Polypropylene plastic (PP) container/cup containing Cotton Candy.

### Example 3—Secondary Packaging

To further extend shelf life of Spun Sugar, the primary packaging is packed and sealed into Secondary Packaging. Secondary Packaging consists of minimum 3-ply-corrugated boxes. The secondary packaging further is supported with:
1. Full Shrink Wrap—to eliminate direct contact with air and lower moisture transmission rate;
2. Commercially available food grade moisture absorbers packed inside 3-ply corrugated boxes to absorb and thereby lower the moisture present inside secondary packaging.

### Example 4

Shelf-life of the Spun Sugar obtained by the methods prescribed by the present invention.

TABLE 1
Testing of the Stability of the Final Product

| | Period - 2017 to late 2018 | | | | | |
|---|---|---|---|---|---|---|
| | | | Avg. weight | | Avg. | |
| | | | in Grams of | | Thickness | |
| | Primary | | Primary | Volume of | of Primary | Days of |
| | Packaging | Covering Lid | Packaging | Primary | Packaging | Best |
| | Cup Samples | used | Container | Packaging | in Micron | before |
| 1 | Polypropylene | 40 Micron | 9 to 10 | 400 ML & | 135 | 45 |
| | Plastic (PP) not in | Aluminium | | above | | |
| | control environment | Foil | | | | |
| 2 | Polypropylene | 40 Micron | 5.5 to 6 | 200 ML | 125 | 75 |
| | Plastic (PP) under | Aluminium | | | | |
| | controlled | Foil | | | | |
| | environment (Temp. | | | | | |
| | 15-25° C. and RH | | | | | |
| | 25-35) | | | | | |
| 3 | Polypropylene | 40 Micron | 7 to 8 | 240 ML | 185 | 100-110 |
| | Plastic (PP) under | Aluminium | | | | |
| | controlled | Foil | | | | |
| | environment (Temp. | | | | | |
| | 15-25° C. and RH | | | | | |
| | 25-35) | | | | | |
| 4 | Polypropylene | 150 GSM | 7 to 8 | 240 ML | 185 | 160-180 |
| | Plastic (PP) under | Laminated | | | | |
| | controlled | Paper Poly | | | | |
| | environment | Lid | | | | |
| 5 | Polypropylene | 40 Micron | 8 to 9 | 225 ML | 190-220 | 120 |
| | Plastic (PP) under | Aluminium | | | | |
| | controlled | Foil | | | | |
| | environment | | | | | |
| 6 | Polypropylene | 150 GSM | 8 to 9 | 225 ML | 190-220 | 9 months |
| | Plastic (PP) | Laminated | | | | |
| | under controlled | Paper Poly | | | | |
| | environment | Lid | | | | |
| | along with | | | | | |
| | Secondary | | | | | |
| | Packaging | | | | | |

Table 1 shows comparative analysis between the commonly available packaging materials used for packaging of the spun sugar. Each sample type has been tested under standard storage conditions and average values in days has been taken in the last column i.e. best before days.

### CONCLUSIONS

Cup thickness of Polypropylene plastic (PP) Cups plays important role and when Polypropylene plastic (PP) Cups of uniform thickness in the range of 190-220 microns are used then the Moisture Vapor Transmission Rate is minimal and Cotton Candy can retain its Original Form up to 9 months and even more. Laminated Paper polyfoil lid blocks sunrays and heat from transmitting inside Primary Packaging Cup. As Spun Sugar itself is about 90% air, packaging of Cotton Candy in the manner depicted herein cuts out sunrays and prevents heat trasnmission from outside which further helps in preserving the thermodynamics and entropy inside the primary packaging which leads to longer shelf life of Cotton Candy as the contents inside the primary packaging are required to be kept isolated from the environement to the maximum extent possible.

While specific language has been used to describe the disclosure, any limitations arising on account of the same are not intended. As would be apparent to a person in the art, various working modifications may be made to the method in order to implement the inventive concept as taught herein. The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

1-7. (canceled)

8. A method/process of industrial production and packaging of Cotton Candy/Spun Sugar comprising:
maintaining a controlled environment by keeping the room temperature and relative humidity of the room in which all the steps are carried out within experimentally derived numeral ranges of 15-25° C. and 25-35 respectively;
making cotton candy/spun sugar by heating sugar at a temperature of 126-140° C. to obtain liquefied sugar in the floss head of a Cotton Candy machine and thereafter instantly cooling the liquefied sugar to collect sugar threads which are further inserted into cups/containers such that the ratio of weight of Spun Sugar (in grams) inserted in the cup/container to the volume of cup/container (in ml) is kept 1:14.70588 or above;
sealing the cup/container containing the cotton candy from the top using heat sealing method with laminated paper polylid consisting of at-least three layers viz. one layer of laminated paper of thickness of minimum 110 GSM, second layer of Aluminum foil and third layer of Poly LD or lacquered material; and
re-packaging the individual units of cups/containers containing Cotton Candy as obtained from above steps into minimum 3-ply-corrugated boxes filled with commercially available food grade moisture absorbers on the inside and Full Shrink Wrap on the outside.

9. The method/process of claim 8, wherein the Spun Sugar/Cotton Candy is inserted into cups/containers of Polypropylene Plastic (PP) material.

10. The method/process of claim 8, wherein the Spun Sugar/Cotton Candy is inserted into cups/containers of Polypropylene Plastic (PP) material having experimentally derived uniform thickness in the range of 190-220 microns.

11. The Spun Sugar/Cotton Candy so obtained using the method/process as described in claim 8 having longer shelf life of up to 9 (nine) months.
